(19) United States
(12) Patent Application Publication
(10) Pub. No.: US 2014/0067899 A1
(43) Pub. Date: Mar. 6, 2014

(54) APPARATUS AND METHOD FOR CONTROLLING WIDGET SERVICE

(71) Applicant: Pantech Co., Ltd., Seoul (KR)

(72) Inventors: Su Jung SHIN, Seoul (KR); Chang Hwan Kim, Seoul (KR); Hye Sun Bae, Seoul (KR)

(21) Appl. No.: 13/936,378

(22) Filed: Jul. 8, 2013

(30) Foreign Application Priority Data
Sep. 5, 2012 (KR) 10-2012-0098244

(51) Int. Cl. H04L 29/08

(52) U.S. Cl. CPC H04L 67/10
USPC 709/201

(57) ABSTRACT

Apparatuses and methods for controlling a widget service of the terminal, including: a launcher management unit to manage one or more launchers; a widget service management unit to remove a widget service of a widget when the widget service is not included in a currently executed launcher of the one or more launchers; and a controller to control the operation of the widget service of the terminal. Accordingly, the widget service control apparatuses and methods manage at least one launcher, manage a widget service set to each of the at least one launcher, and remove a service of a widget unbound to a second selected launcher when a first selected launcher out of the at least one launcher is changed to the second selected launcher.

### CROSS-REFERENCE TO RELATED APPLICATION

This application claims priority to and the benefits under 35 U.S.C. §119 of Korean Patent Application No. 10-2012-0098244, filed on Sep. 5, 2012, the contents of which are herein incorporated in its entirety by reference for all purposes as if fully set forth herein.

### BACKGROUND

1. Field

Exemplary embodiments relate to apparatuses and methods for controlling a widget service for increasing capability of a mobile communication terminal.

2. Discussion of the Background

Generally, mobile communication terminals manage only a widget application recorded in an extensible markup language (XML) in a framework rather than selectively managing services of widget applications.

Widget services are typically individually executed through a service management unit in the same or similar manner as the application service. Widgets may be listed and managed by a launcher management unit. And, the launcher management unit may transmit an execution event to widgets on the list when a launcher restarts or when the mobile communication terminal reboots. Also, the widget services may be independently executed in corresponding widgets.

The widget service control structure may also be applied in the same or similar manner for removal of widgets. In this regard, an unbind operation of a widget service of a widget application being executed is typically not managed in a framework layer. When individual widget applications are unbound in a launcher, the widget application may unbind the widget service.

However, when the mobile communication terminal installs and uses at least one launcher, a widget service bound to a launcher other than a selected launcher may be executed in a background.

In this case, although the selected launcher is switched, since the respective widget services are independently managed in each corresponding widget by the service management unit, the launcher management unit typically does not receive an event related to the switching of the launcher from the widget. Therefore, the launcher management unit may not determine the unbind operation of the widget service.

Since the widget service is present in a process layer, a process identifier (ID) may be assigned to the widget service. The mobile communication terminal may determine a maximum number of process IDs. The application of the widget may be executed within the determined maximum number of process IDs. When the number of process IDs reaches the maximum number, the mobile communication terminal may remove the application being executed in the background and execute a new application.

When removing the bound widget service, the launcher needs to process in each corresponding widget service. However, even when a widget service unbind operation is not added in some widget applications and, therefore, the widget applications are removed, the widget service may still be potentially executed in the background.

In addition, the widget service bound to the launcher other than the selected launcher is potentially executed in the background though not used by a user, which consequently may unnecessarily increase memory capacity and the number of process IDs.

### SUMMARY

Exemplary embodiments relate to a terminal to control a widget service of the terminal, including: a launcher management unit to manage one or more launchers; a widget service management unit to remove a widget service of a widget when the widget service is not included in a currently executed launcher of the one or more launchers; and a controller to control the operation of the widget service of the terminal.

Exemplary embodiments also relate to a terminal to control a widget service of the terminal, including: a plurality of launchers; a widget service management unit to determine if a widget service of a widget is used in one or more launchers of the plurality of launchers and to remove the widget service of a widget when the widget service of the widget is not included in a currently executed launcher of the plurality of launchers; and a controller to control the operation of the widget service of the terminal.

Exemplary embodiments further relate to a method for controlling a widget service of a terminal, including: determining a currently executed launcher of one or more launchers of a widget service of a terminal; and removing a widget service of a widget when the widget service of the widget is not included in the currently executed launcher.

Exemplary embodiments additionally relate a method for controlling a widget service of a terminal, including: changing a currently executed launcher operating in the terminal from a first launcher to a second launcher; determining from a widget list if a widget is bound to the currently executed second launcher; and terminating a widget service of one or more widgets determined as not bound to the currently executed second launcher based on the determination.

Exemplary embodiments further relate to a method for controlling a widget service of a terminal, including: determining running service and process information of a widget service of one or more widgets; determining if one or more widgets corresponding to the determined running service and the process information are used in one or more launchers and not used in a currently executed launcher; and removing and unbinding the widget service of the one or more widgets that are used only in one or more launchers and not used in the currently executed launcher.

Exemplary embodiments also relate to a method for controlling a widget service of a terminal, including: determining a currently executed launcher of one or more launchers of a widget service of a terminal; and removing a widget service of a widget when the widget service of the widget is not included in the currently executed launcher.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a widget service control apparatus according to exemplary embodiments of the present invention.

FIG. 2 is a block diagram illustrating a detailed configuration of a widget service control apparatus according to exemplary embodiments of the present invention.

FIG. 3 is a diagram illustrating a widget according to exemplary embodiments of the present invention.

FIG. 4 is a diagram illustrating a detailed configuration of a widget service management unit according to exemplary embodiments of the present invention.

FIG. 5 is a flowchart illustrating a widget service control method according to exemplary embodiments of the present invention.

FIG. 6 is a flowchart illustrating a widget service removal method according to exemplary embodiments of the present invention.

FIG. 7 is a flowchart illustrating a widget service removal method according to exemplary embodiments of the present invention.

### DETAILED DESCRIPTION

The invention is described more fully hereinafter with reference to the accompanying drawings, in which embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Hereinafter, exemplary embodiments of terminals, apparatuses and methods for controlling a widget service of a terminal will be described in more detail with reference to the drawings

It will be understood that when an element is referred to as being “connected to” another element, it can be directly connected to the other element, or intervening elements may be present; and, as to wireless communication, may be interpreted as being wirelessly connected, such as a wireless connection between a terminal and a base station or external server, for example.

Hereinafter, a terminal may include, for example, a terminal, a mobile communication terminal, handheld, portable or tablet computer or communication devices, or other apparatuses, for controlling a widget service of a terminal, will be described in more detail with reference to the drawings, and should not be construed in a limiting sense. Also, the terminal, and the units, modules, elements, devices and components of the terminals herein described, include hardware and software, and can also include firmware, to perform various operations of the terminal including those for controlling a widget service of a terminal, including those described herein, as may be known to one of skill in the art. As such, terminal as used herein should not be construed in a limiting sense and may include the above and other apparatuses for controlling a widget service of a terminal.

Also, a terminal may include, for example, any of various devices or structures used for wireless or wired communication for controlling a widget service of a terminal and can be wired or wireless connected to a base station, server or network, and may include another terminal, and also may include hardware, firmware, or software to perform various operations for controlling a widget service of a terminal, including those described herein, as may be known to one of skill in the art.

Hereinafter, a terminal, such as including, for example, a terminal, a mobile terminal, a mobile communication terminal, handheld, portable or tablet computer or communication devices, or other apparatuses, and methods for controlling a widget service of a terminal will be described in more detail with reference to the drawings.

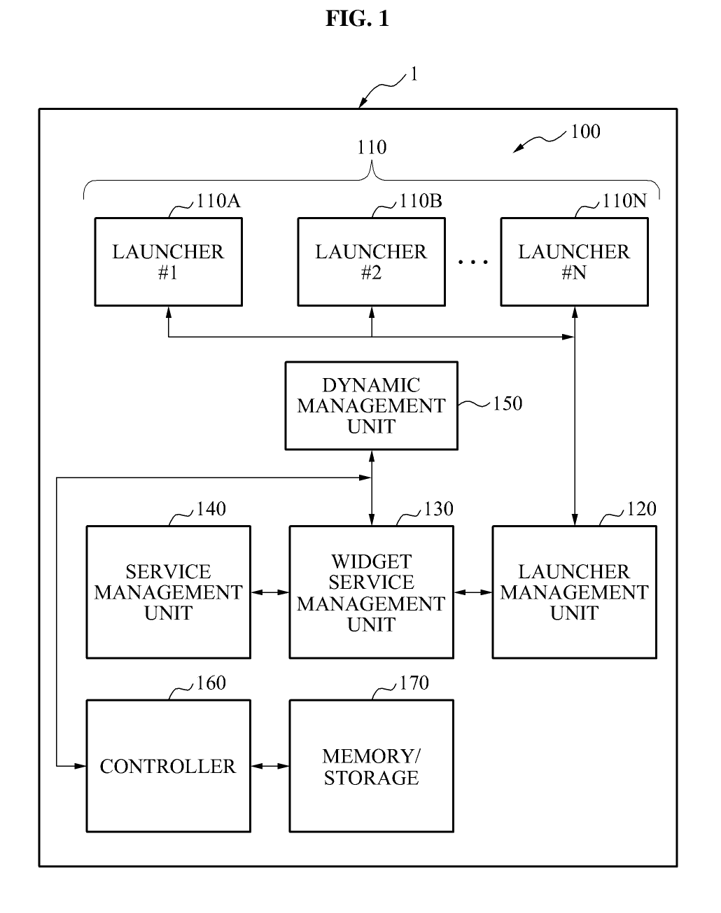

FIG. 1 is a block diagram illustrating a configuration of a widget service control apparatus 100 of a terminal 1 according to exemplary embodiments of the present invention.

Referring to FIG. 1, the widget service control apparatus 100 of the terminal 1 may include a launcher management unit 120, a widget service management unit 130, and a service management unit 140, and a dynamic management unit 150. The launcher management unit 120 may manage at least one launcher 110, including a plurality of launchers 110A, 110B-110N illustrated in FIG. 1. The service management unit 140 may manage a widget service set corresponding to each of the at least one launcher 110. And the dynamic management unit 150 may provide information on and manage one or more of the launchers 110, for example.

The terminal 1 also includes a memory/storage unit 170 to store data, applications or programs for operations of the terminal 1 and for operations of the widget service control apparatus 100 for controlling a widget service of the terminal 1, according to exemplary embodiments.

Also, the terminal 1 includes a controller 160, such as configured as a processor, as may perform an overall control of the widget service control apparatus 100, such as to control operation of the widget service of the terminal 1 of FIG. 1. In this regard, the controller 160 may also perform operations of the one or more launchers 110, the launcher management unit 120, the widget service management unit 130, the service management unit 140, the dynamic management unit 150 and the memory/storage unit 170, as well as may control or perform other operations of the terminal 1. In the exemplary embodiments of the widget service control apparatus 100 of the terminal 1 of FIG. 1, the configurations of the described units have been illustrated separately in order to describe each individually. Accordingly, in the widget service control apparatus 100 of terminal 1 all of the configurations or operations of the described units may be designed to be processed by the controller 160, and, alternatively, only a portion of the configurations or operations of the described units may be designed to be processed by the control unit 160, according to exemplary embodiments.

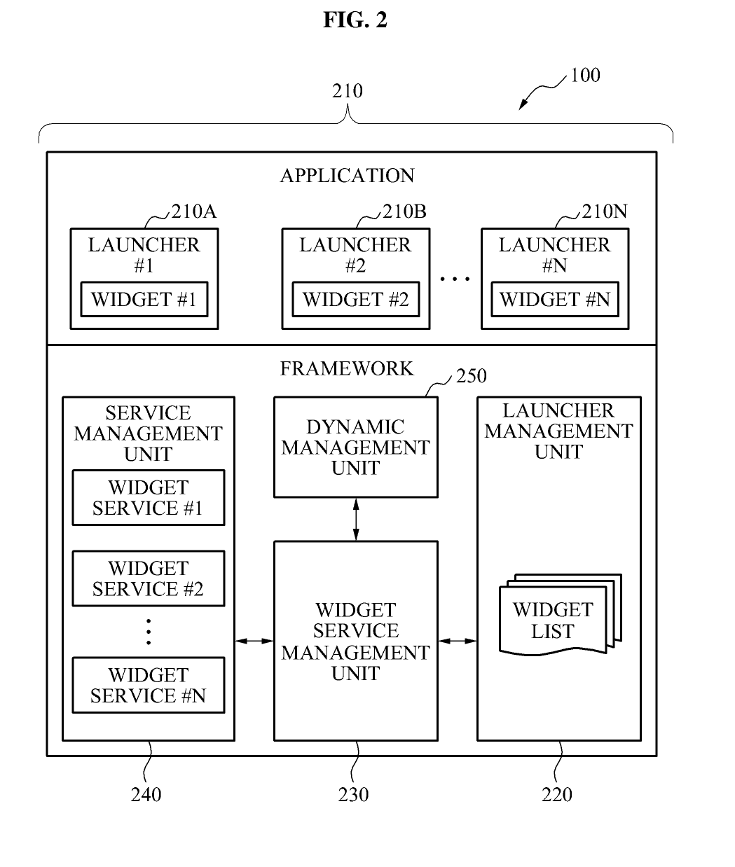

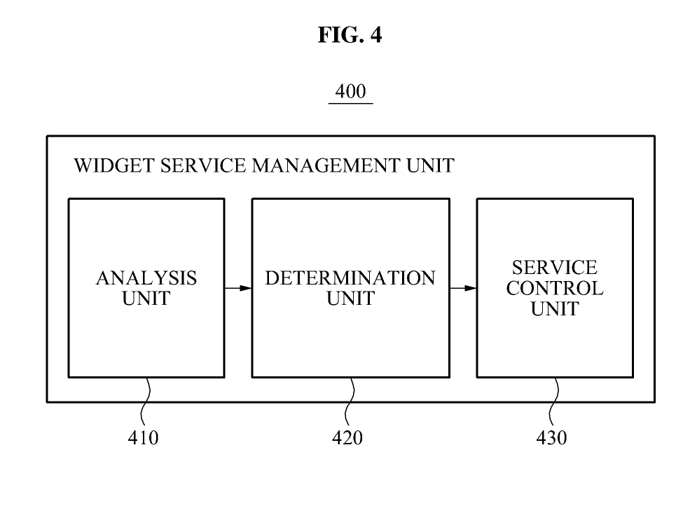

The terminal 1 and the widget service control apparatus 100 including the controller 160, the one or more launchers 110, the launcher management unit 120, the widget service management unit 130, the service management unit 140, the dynamic management unit 150 and the memory/storage unit 170, as well as the one or more launchers 210, the launcher management unit 220, the widget service management unit 230, the service management unit 240, and the dynamic management unit 250 of FIG. 2 and the widget management service unit 400 of FIG. 4, associated with and may include any of various memory or storage media for storing software, program instructions, data files, data structures, and the like, and are associated with and may also include any of various processors, computers or application specific integrated circuits (ASICs) for example, to implement various operations for controlling a widget service of the terminal 1, as described herein.

Likewise, the terminal 1 and the widget service control apparatus 100 including the controller 160, the one or more launchers 110, the launcher management unit 120, the widget service management unit 130, the service management unit 140, the dynamic management unit 150 and the memory/storage unit 170, as well as the one or more launchers 210, the launcher management unit 220, the widget service management unit 230, the service management unit 240, and the dynamic management unit 250 of FIG. 2 and the widget management service unit 400 of FIG. 4, are associated with and may include any of various memory or storage media for storing software, program instructions, data files, data structures, and the like, and are associated with and may also include any of various processors, computers or application specific integrated circuits (ASICs) for example, to implement various operations for controlling a widget service of the terminal 1, as described herein.

And although the terminal 1 and the widget service control apparatus 100 including the controller 160, the one or more launchers 110, the launcher management unit 120, the widget service management unit 130, the service management unit 140, the dynamic management unit 150 and the memory/storage unit 170, as well as the one or more launchers 210, the launcher management unit 220, the widget service management unit 230, the service management unit 240, and the dynamic management unit 250 of FIG. 2 and the widget management service unit 400 of FIG. 4, and the herein described units, processors, memories, modules, elements, devices or components of the terminal 1 and the widget service control apparatus 100 may be described as separate units, processors, memories, modules, elements, devices or components, aspects are not limited thereto such that each of units, processors, memories, modules, elements, devices or components may be combined with any one or more units, processors, memories, modules, elements, devices or components, for example, and should therefore should not be construed in a limiting sense.

Also, the software, media and program instructions as may be included in or used by the terminal 1 and the widget service control apparatus 100 including the controller 160, the one or more launchers 110, the launcher management unit 120, the widget service management unit 130, the service management unit 140, the dynamic management unit 150 and the memory/storage unit 170, as well as the one or more launchers 210, the launcher management unit 220, the widget service management unit 230, the service management unit 240, and the dynamic management unit 250 of FIG. 2 and the widget management service unit 400 of FIG. 4, may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

Continuing with reference to FIG. 1, when a first selected launcher of the at least one launcher 110 is changed to a second selected launcher, such as from launcher 110A to 110B, for example, the widget service management unit 130 may remove a service of a widget not bound to the second selected launcher. The first selected launcher and the second selected launcher may be disposed at the dynamic management unit 150, for example.

A widget service control apparatus, such as widget service control apparatus 100, according to exemplary embodiments, may include the launcher management unit 120 to manage at least one launcher 110, a service management unit 140 to manage a widget service set corresponding to the at least one launcher 110, and a widget service management unit 130 to remove a widget service related to a widget when the widget is removed from the corresponding launcher 110 being currently executed out of the at least one launcher.

Throughout the specification, a term “launcher” denotes or corresponds to a software program installed in a mobile communication terminal such as a personal digital assistant (PDA) and a wireless broadband (WiBro) terminal, as a terminal 1, providing user convenience, to facilitate use of various operations of a mobile communication terminal, such as the terminal 1, including access to an Internet site and execution of an application program, by supporting a user interface (UI) related to corresponding operations.

The launcher, such as the at least one launcher 110, may be an independent application program that generally enables or facilitates relatively convenient access to an application and may provide a design improvement. Using the launcher, a user may set use environments of the user's mobile communication terminal, such as the terminal 1, such as in relation to frequently used operations in consideration of the user's tastes, preferences, job, and the like, for example.

The launcher 110 may correspond to a screen that enables the user to access applications installed in the mobile communication terminal, such as the terminal 1. The screen may include menu icons corresponding to the respective applications, for example.

According to the setting by the user, the launcher 110 may be set to display one or more applications to suit or correspond to a platform of the mobile communication terminal, such as the terminal 1, or displayed category by category.

Additionally, throughout the specification, a “bound” state may denote a state in which an execution event of a service provided by an application is available to be transmitted to a launcher, such as the launcher 110. In this regard, in the “bound” state, the execution event of the service provided by the application related to a widget may be generated and transmitted to the launcher 110. The “bound” state may include both generation and transmission of the execution event to the launcher 110, or only generation of the execution event without transmission to the launcher 110. Conversely, an “unbound” state may denote a state in which transmission of the execution event of the service provided by the application to the launcher 110 is unavailable. That is, since the execution event of the service provided to the application related to the widget is not generated, transmission of the execution event to the launcher 110 may be relatively difficult or impossible. That is, the launcher 110 may not provide a service of an unbound application. Furthermore, throughout the specification, the “bound” state and the “unbound” state may be controlled directly by the user of the terminal 1, for example.

According to exemplary embodiments, a launcher, such as the launcher 110, denotes or corresponds to a launcher executed in the mobile communication terminal, such as the terminal 1, at typically a highest priority. The first selected launcher may correspond to a selected launcher set before the user changes the selected launcher. The second selected launcher may correspond to a selected launcher set as a new selected launcher according to a user request, for example, according to exemplary embodiments.

Furthermore, a term “launcher change” may correspond to activation of another launcher 110 other than a currently activated launcher 110 and support of the UI with respect to corresponding operations by the another launcher 110. For example, the widget service control apparatus 100 may inactivate operation of a first launcher 110, such as the launcher 110A, being currently activated and activate operation of a second launcher 100, such as the launcher 110B, to thereby execute a corresponding application using the second launcher 100, for example.

In the following description, “registration of a widget with a launcher” may correspond to binding a widget to a launcher, such as the launcher 110, and setting the execution event with respect to the service to a transmittable state using a corresponding launcher 110. In this regard, the launcher 110 may display a widget view of icons, lists, or the like with respect to the bound widget on a screen of the terminal 1. For example, the widget service control apparatus 100 may register the widget with the launcher 110 and thereby display the icons or lists corresponding to the registered widget on the screen of the terminal 1 displayed through the launcher 110.

In addition, “removal of a widget from a launcher” may correspond to unbinding a widget bound to a launcher 110, such as the launcher 110A, and thereby setting an execution event related to a widget service to be in a non-transmittable state using a corresponding launcher 110. In this regard, the corresponding launcher 110 may remove a widget view of icons, lists, or the like related to the unbound widget from the screen of the terminal 1. For example, the widget service control apparatus 100 may remove the widget from the launcher 110 and thereby remove the icons or lists corresponding to the removed widget from the screen of the terminal 1 being displayed through the corresponding launcher 110.

FIG. 2 is a block diagram illustrating a detailed configuration of a widget service control apparatus 1001, according to exemplary embodiments of the present invention.

Referring to FIG. 2, the widget service control apparatus 100 may include the launcher management unit 220 to manage at least one launcher 210, such as the launchers 210A, 201B-210N, a service management unit 240 to manage a widget service set corresponding to each of the at least one launcher 210, and a widget service management unit 230 to remove a service of a widget unbound to a second selected launcher 210, such as the launcher 210B, when a first selected launcher 210, such as the launcher 210A, out of the at least one launcher 210 is changed to the second selected launcher 210. In this regard, the widget service management unit 230 may correspond to a structure unit of a framework that controls a running service of a widget application that controls the widget service of the terminal 1, for example. The first selected launcher 210, such as the launcher 210A, and the second selected launcher, such as the launcher 210B, may be located in an application layer and managed by the dynamic management unit 250 of FIG. 2, for example, according to exemplary embodiments.

The widget service control apparatus 100 of the terminal 1 of FIG. 2, according to exemplary embodiments, is similar to the widget service control apparatus 100 of the terminal 1 of FIG. 1. Therefore, unless described otherwise, corresponding components, elements, units, devices and modules of the widget service control apparatus 100 of the terminal 1 of FIG. 2, such as the one or more launchers 210, the launcher management unit 220, the widget service management unit 230, the service management unit 240, and the dynamic management unit 250 of FIG. 2 as may operate in a similar manner as described with respect to those corresponding components, elements, units, devices and modules of the widget service control apparatus 100 of the terminal 1 of FIG. 1, and descriptions of the same or similar components, elements, units, devices and modules as those of the widget service control apparatus 100 of the terminal 1 of FIG. 1 may be simplified or omitted.

Throughout the specification, the term “widget” refers or corresponds to a graphic interface supporting a relatively more efficient interaction between a user and applications, operation systems (OS), and the like, of the terminal 1. When the user wants to use operations of a particular application, the widget may enable the user of the terminal 1 to use a desired service directly through a standby screen of the terminal 1, typically without executing the particular application. Also, the widget may enable the user of the terminal 1 to use the desired or selected service directly, such as through the standby screen of the terminal 1, typically without having to visit a portal site of a content providing site, for example, according to exemplary embodiments.

The term “service” denotes or corresponds to a background process that may periodically perform a particular task typically without a UI, for example. Also, the term “widget service” denotes or corresponds to a service operated in relation to a widget, for example.

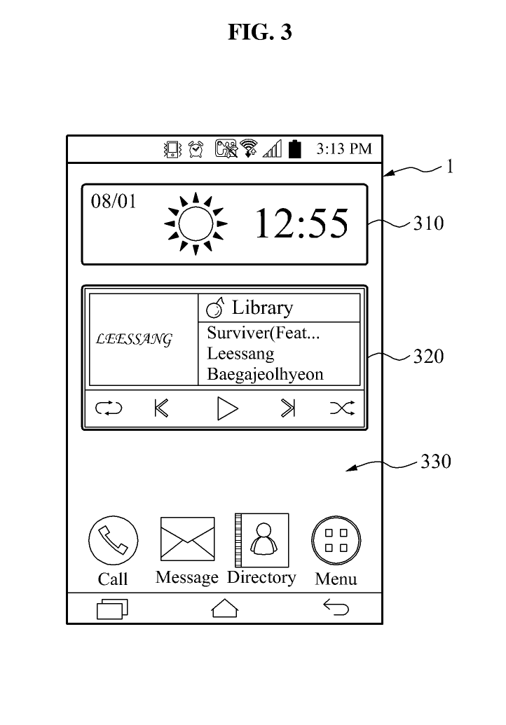

FIG. 3 is a diagram illustrating an example widget displayed on a screen 330 of the terminal 1 according to exemplary embodiments of the present invention.

Referring to FIG. 3, the widget 310 and the widget 320 may provide services such as the weather and clock widget 310 and the music player widget 320, registered with a standby screen that displays applications for controlling basic operations of a mobile communication terminal, such as the terminal 1. A user may download an application providing a frequently used service by visiting a download site, and determine whether to display the downloaded application in the form of the widget, such as widgets 310 or 320, for example, on the standby screen, such as on the screen 330 of the terminal 1. In this regard, the user may be provided with various services implemented by the widget in real time by the mobile communication terminal, such as the terminal 1, without directly executing the application, for example, according to exemplary embodiments.

For example, when the user of the terminal 1 downloads and installs a weather application through a download site, the user may also generate the weather and clock widget 310 implementing a service of the weather application and set the weather and clock widget 310 to be displayed on the standby screen, such on the screen 330, of the mobile communication terminal, such as the terminal 1. That is, when desirable or necessary, the user may easily check the weather through the weather and clock widget 310 displayed on the standby screen, such as on the screen 330 of the terminal 1, typically without having to execute the weather application, for example, according to exemplary embodiments.

The user of the terminal 1 may therefore obtain desired information or use a desired service conveniently, by registering a frequently used widget service in the form of the widget, such as widgets 310 and 320, with the standby screen 330 of the terminal 1.

Referring again to FIG. 2, the widget service management unit 230 may receive running service information and a process identifier (ID) related to the widget from the widget service management unit 240, determine whether the widget is redundantly used in different launchers including the currently executed launcher 210 based on the process ID, and remove or retain a service of the widget depending on the determination result, for example, according to exemplary embodiments. And if the redundant service of the widget is included in the currently executed launcher 210, the widget service of the widget is retained as the determination result and if the redundant service of the widget is not included in the currently executed launcher 210, the widget service of the widget is removed, for example.

FIG. 4 is a diagram illustrating a detailed configuration of a widget service management unit 400 of the widget service control apparatus 100, similar to the widget service management units 130 and 230, according to exemplary embodiments of the present invention.

Referring to FIG. 4, the widget service management unit 400 may include an analysis unit 410, a determination unit 420, and a service control unit 430, for example.

According to exemplary embodiments, the analysis unit 410 may analyze a widget list bound to the at least one launcher, such as launcher 110 or launcher 210, and based on the analysis determine whether the widget is redundantly used in the different launchers, such as based on a corresponding widget list, for example. The determination unit 420 may determine whether the widget is bound to the second selected launcher, which is the currently executed launcher, when it is determined the widget is not redundantly used in the different launchers, such as when a first selected launcher of the one or more launchers is changed to the second selected launcher, for example. Here, the service control unit 430 may remove the service of the widget when the widget is not bound to the second selected launcher or to the currently executed launcher, for example, according to exemplary embodiments.

Referring again to FIG. 2, the widget service management unit 230 may receive widget information per the launchers 210 included in the widget list located in the launcher management unit 220, and receive information on selected launchers 210 from the dynamic management unit 250. Next, the widget service management unit 230 may select a widget not used in a launcher 210 designated by the user of the terminal 1 based on the widget information and the information on selected launchers 210, for example, according to exemplary embodiments.

The widget list may include the process ID information of the at least one widget related or corresponding to one or more widgets set by the respective or corresponding one or more launchers, such as the launchers 210, and host information related or corresponding to a launcher executing the one or more widgets out of the at least one launcher, such as at least one launcher 210. A same widget service may be set in different launchers, such as launchers 210A and 210B, for example. The respective widgets may be managed by a process ID. The widget list refers or corresponds to a list for transmitting events between a widget, such as widgets 310 or 320 and a launcher, such as the at least one launcher 210. The widget list typically does not directly control the widget service.

The widget service management unit 230 may perform control of the widget service so that only a widget bound to the second selected launcher, such as launcher 210B, is executed when the mobile communication terminal, such as the terminal 1, executing the second selected launcher 210 B is rebooted, for example, according to exemplary embodiments.

Also, the widget service management unit 230 may remove the service of the widget when the process ID of the widget corresponding to a removed application is included in the widget list, according to exemplary embodiments.

Moreover, the widget service management unit 230 may terminate the service of the widget being executed by the first selected launcher, such as launcher 210A, when the first selected launcher is changed to the second selected launcher, such as launcher 210B, for example, according to exemplary embodiments.

The widget service control apparatus 100 according to exemplary embodiments of the present invention may manage a selected launcher, such as one or more of launchers 210, using the dynamic management unit 250, and initialize the selected launcher 210 when a new launcher 210 is set or setting of the selected launcher is cancelled. The widget service control apparatus 100 may also be operated without a selected launcher, such as the at least one launcher 210, until the user of the terminal 1 resets the selected launcher, such as at least one launcher 210, for example, according to exemplary embodiments.

When the user of the terminal 1 sets a particular launcher, such as at least one launcher 210, to be the selected launcher 210, the widget service control apparatus 100 may operate the set selected launcher 210 all the time while the standby screen, such as screen 330 of the terminal 1 is displayed. The selected launcher 210 may be a launcher frequently used by the user of the terminal 1, for example. The other launchers of the one or more launchers 210, for example, may be set to be in a standby mode until the user of the terminal 1 changes the selected launcher 210, according to exemplary embodiments.

The widget service management unit 230 may determine a widget, such as widgets 310 or 320, actually used by the user of the terminal 1, by collecting the widget list and information on the selected launcher 210. In addition, using the widget list and the information on the selected launcher 210, the widget service management unit 230 may compare a widget service corresponding to one or more widgets actually or currently not used by the user of the terminal 1 with running service information and the process ID of the one or more widgets, thereby determining whether to continue execution or to stop execution of the widget service of the one or more widgets based on the comparison, for example, according to exemplary embodiments. In this regard, where the widget service corresponding to one or more widgets is actually or currently not used by the terminal 1, the widget service management unit 230 determines to stop execution of the widget service of the widget not actually or currently used by the terminal 1 and to continue execution of the widget service of the widget actually or currently used by the terminal 1, for example.

The widget service management unit 230 may determine a bind operation or an unbind operation of the widget service of one or more widgets, for example, according to exemplary embodiments. Also, the widget service management unit 230 may transmit event information corresponding to the unbind operation to the service management unit 240, when the unbind operation is determined, so that the unbind operation of the widget service of the corresponding widget is actually performed by the service management unit 240 based on the determination, according to exemplary embodiments.

Hereinafter, widget service control methods according to exemplary embodiments of the present invention will be described.

When the first selected launcher 210, such as launcher 210A, of the at least one launcher 210 is changed to the second selected launcher 210, such as launcher 210B, the widget service control methods according to exemplary embodiments may remove the service of the widget, such as widgets 310 or 320, unbound to the second selected launcher 210B. Accordingly, efficiency of resources of the mobile communication terminal, such as the terminal 1, may be increased or enhanced, for example.

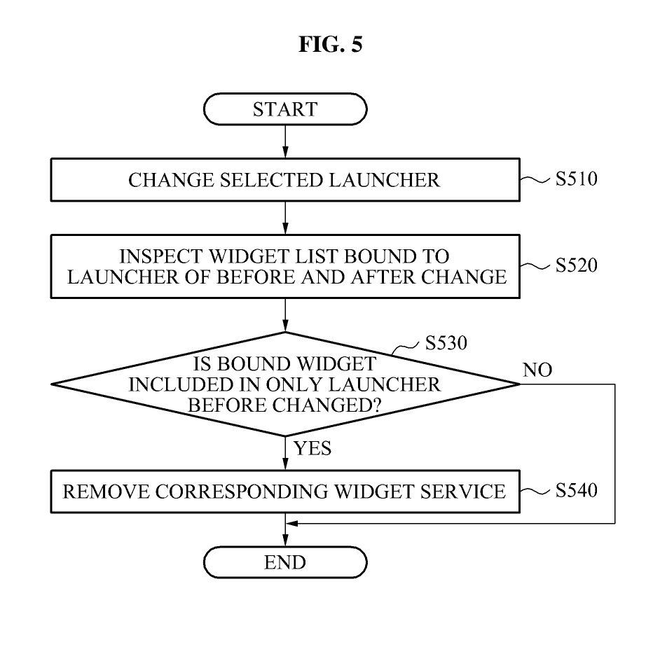

FIG. 5 is a flowchart illustrating a widget service control method according to exemplary embodiments of the present invention.

Referring to FIG. 5, in operations S510 and S520, when a selected launcher, such as launcher 210 is changed as the currently executed launcher operating in the terminal 1, the widget service control apparatus 100 according to exemplary embodiments of the present invention may inspect or determine from a widget list bound to a launcher to determine if a widget service of a widget is bound to the currently executed launcher, before or after the change of the selected launcher 210. Here, the widget service control apparatus 100 may terminate a widget service of one or more widgets used in the first selected launcher, such as launcher 210A, but not in the widget service of or is not bound to the second selected launcher as the currently executed launcher, such as the when the currently executed launcher is the launcher 210B, set when the first selected launcher 210 is changed to the second selected launcher 210, such as launcher 210B, for example, such as based on the inspection of the widget list, for example.

When setting of the first selected launcher 210, such as launcher 210A, is cancelled and the widget executed in the first selected launcher needs or is to be used in the second selected launcher 210, such as launcher 210B, the widget service control apparatus 100 may maintain a bound state with respect to the corresponding widget so that execution of the widget service is continued, for example, according to exemplary embodiments.

When the widget used in the first selected launcher 210, such as launcher 210A, is not used in the second selected launcher 210, such as launcher 210B, the widget service control apparatus 100 may unbind the widget executed in only the first selected launcher 210 by the service management unit 240, for example according to exemplary embodiments.

The widget service control apparatus 100 may determine whether a same widget, such as widgets 310 or 320, for example, is present in different launchers 210. That is, in operation S530, when the first selected launcher 210, such as launcher 210A, is changed to the second selected launcher 210, such as launcher 210B, the widget service control apparatus 100 may determine whether the second selected launcher 210 includes any widget executed in the first selected launcher 210.

For example, in operation S530, when widgets a, b, c, and d are bound to the first selected launcher 210, such as launcher 210A, and widgets c, d, e, and f are bound to the second selected launcher 210, such as launcher 210B, the widget service control apparatus 100 may determine that the widgets c and d are redundantly used in the first selected launcher 210A and the second selected launcher 210B. In this regard, the widgets a and b may be determined to be bound only to the first selected launcher 210A but not to the second selected launcher 210B at operation S530, according to exemplary embodiments.

In operation S530, when widgets, such as widgets 310 or 320, are redundantly used in different launchers, such as launchers 210A and 210B, for example, the widget service control apparatus 100 may determine whether widgets bound to the different launchers 210A and 210B are identical. In this regard, the widget service control apparatus 100 may determine whether a widget bound to the first selected launcher 210A is identical to a widget bound to the second selected launcher 210B. Also, at operation S530, if the widget service control apparatus 100 determines that the bound widget, such as widget 310 or 320, for example, is included only in the first selected launcher 210A before the selected launcher 210 is changed to the second selected launcher 210B, the process proceeds to operation S540. If not, the process proceeds to End, according to exemplary embodiments

At operation S540, when the widget, such as widget 310 or 320, bound to the first selected launcher 210A is not identical to the widget bound to the second selected launcher 210B, the widget service control apparatus 100 may remove a widget service corresponding to the widget since the widget is executed in only the first selected launcher 210A. In this regard, the widget service control apparatus 100 may maintain execution of the widget service of the widget bound to the first selected launcher 210A that is identical to the widget bound to the second selected launcher 210B executed in the second selected launcher 210A, which is currently used by the user of the terminal 1, and remove a widget service of or related to the widget executed in or bound only the first selected launcher 210A that is not identical to the widget bound to the second selected launcher 210B at operation S540. From operation S540, the process proceeds to End.

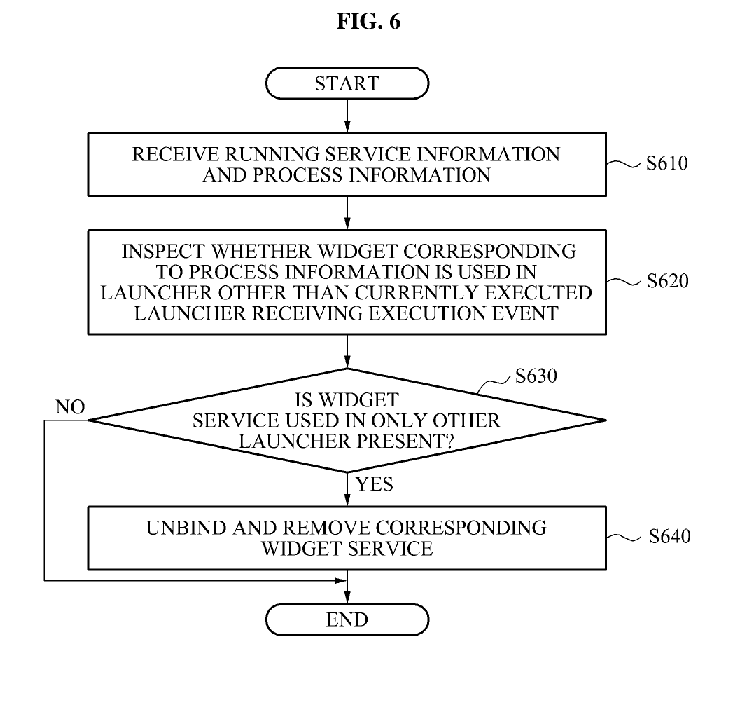

FIG. 6 is a flowchart illustrating a widget service removal method according to exemplary embodiments of the present invention.

Referring to FIG. 6, the widget service management unit 230 may receive running service information and process information, such as the process ID, of the widget service or one or more widgets from and determined by the service management unit 240 in operation S610. And, at operation S620, the widget service management unit 230 of the widget service control apparatus 100 may inspect or determining whether a widget, such as widget 310 or 320, corresponding to the process information and running service information is used in one or more launchers 210 other than a currently executed launcher 210 receiving the execution event.

At operation S630, the widget service management unit 230 of the widget service control apparatus 100 determines whether the same widget service of a widget is used only in one or more other launchers 210 other than the currently executed launcher 210. If not, the process proceeds to End. However, if at operation S630 it is determined that the same widget service is used only in the other one or more launchers 210, the widget service management unit 230 may transmit, to the service management unit 240, an unbind request with respect to the widget service of a widget which is not identical to the widget service of the widget used in other launchers 210, that is, the widget service is used or included only in other launchers 210 and not included or used in the currently executed launcher 210 of the terminal 1.

At operation S640, the unbind request with respect to the widget service is transmitted to the service management unit 240 unbinds and removes the widget service of one or more widgets that are used only in the one or more other launchers 210. Here, when the widget service of the widget is removed at operation S640, the service management unit 240 may also remove the process ID of the widget corresponding to the widget service based on the transmitted unbind request, for example, according to exemplary embodiments. From operation S640, the process proceeds to End.

When the mobile communication terminal, such as terminal 1, is rebooted, the widget service control apparatus 100 may control the launcher management unit 120/220 to transmit the execution event only to the widget set to the selected launcher 110/210, using the widget service management unit 130/230.

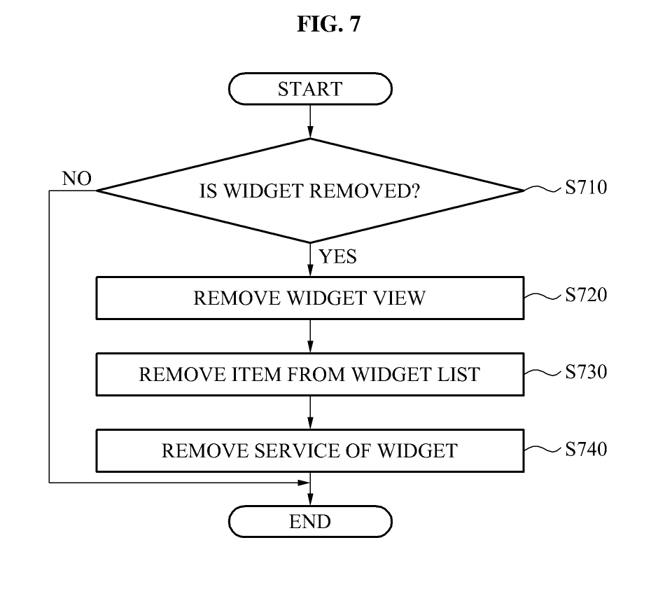

FIG. 7 is a flowchart illustrating a widget service removal method according to exemplary embodiments of the present invention.

Referring to FIG. 7, at operation S710, the widget service control apparatus 100 may determine whether the user of the terminal 1 removed a widget generated on the standby screen, such as standby screen 330. If not, the process proceeds to End. And, if so, the widget service control apparatus 100 proceeds to operation S720 to remove the widget service corresponding to the removed widget by unbinding the widget service. That is, the widget service control apparatus 100 may unbind and remove the widget service corresponding to the removed widget when the widget is removed from the launcher 210 being currently executed. In this regard, at operation S720, the widget service control apparatus 100 may remove a view of the widget being removed from the launcher 210 being currently executed and transmit a removal event to an application corresponding to the widget.

With respect to the currently unremoved widget service corresponding to the widget being removed, the widget service management unit 230 may receive information on the widget being removed. When the widget list includes a process corresponding to the process ID of the removed widget and the running service information, the widget service control apparatus 100 may remove the item corresponding to the widget being removed from the widget list at operation S730 and remove the corresponding widget service in operation S740. From operation S740, the process proceeds to End.

In this regard, the widget service control apparatus 100 may check whether the widget service being removed is used in other widgets, and transmit an event to the service management unit 240 when the widget service is removed so that the process ID is removed, for example, according to exemplary embodiments.

According to exemplary embodiments of the present invention, a state of a widget service may be controlled and, therefore, a latent widget service may be removed.

Also, according to exemplary embodiments of the present invention, an increase in memory of the terminal and reckless generation of process IDs may be prevented, thereby increasing or enhancing management efficiency of resources of the terminal.

Further, according to exemplary embodiments of the present invention, the widget service control apparatus may be implemented at a control framework and directly applied to an actual product, such as being implemented in a terminal, typically without additional hardware. Therefore, cost efficiency may be enhanced and additional cost may be minimized.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to control a widget service of the terminal, the terminal comprising:
a launcher management unit to manage one or more launchers;
a widget service management unit to remove a widget service of a widget when the widget service is not included in a currently executed launcher of the one or more launchers; and
a controller to control the operation of the widget service of the terminal.

2. The terminal of claim 1, further comprising:
a dynamic management unit to provide information on and manage one or more of the launchers.

3. The terminal of claim 1, wherein the widget service management unit removes the widget service of a widget not bound to a second launcher, the second launcher being the currently executed launcher, when a first launcher including the widget service is changed to the second launcher.

4. The terminal of claim 1, wherein the widget service management unit receives, from the widget service management unit, running service information and a process identifier (ID) corresponding to a widget and determines if the widget is redundantly used in different launchers including the currently executed launcher based on the process ID, and removes or retains the widget service of the widget based on a determination result.

5. The terminal of claim 1, wherein the widget service management unit comprises:
an analysis unit to analyze a widget list bound to the one or more launchers and to determine based on the analysis if a widget is redundantly used in different launchers including the currently executed launcher based on a corresponding widget list;
a determination unit to determine if the widget is bound to a second launcher as the currently executed launcher of the one or more launchers when it is determined the widget is used in a first launcher of the one or more launchers; and
a service control unit to remove the widget service of the widget when it is determined the widget is not bound to the currently executed second launcher.

6. The terminal of claim 1, wherein:
the widget service management unit compares a widget service corresponding to one or more widgets currently not used by the terminal with running service information and a process identifier (ID) of the one or more widgets and determines to continue execution or stop execution of the widget service of the one or more widgets based on the comparison.

7. The terminal of claim 1, wherein
the widget service management unit determines at least one of a bind operation or an unbind operation of the widget service of the widget.

8. The terminal of claim 7, further comprising:
a service management unit to perform the unbind operation of the widget service based on event information corresponding to the unbind operation received from the widget service management unit when the unbind operation is determined.

9. The terminal of claim 1, wherein:
the widget service of the widget is unbound from the currently executed launcher when the widget is removed from the currently executed launcher.

10. The terminal of claim 1, wherein the widget service management unit determines if a widget service of a widget is used in more than one of the one or more launchers.

11. A method for controlling a widget service of a terminal, the method comprising:
determining a currently executed launcher of one or more launchers of a widget service of a terminal; and
removing a widget service of a widget when the widget service of the widget is not included in the currently executed launcher.

12. The method of claim 11, further comprising:
changing the currently executed launcher from a first launcher to a second launcher, and
removing the widget service of a widget not bound to the second launcher as the currently executed launcher.

13. The method of claim 11, further comprising
determining if the widget is redundantly used in different launchers of the one or more launchers;
removing the widget service of the widget based on the determination result of the widget not being included in the currently executed launcher; and
retaining the widget service of the widget based on the determination result of the widget being included in the currently executed launcher.

14. The method of claim 11, further comprising:
analyzing a widget list bound to the one or more launchers;
determining based on the analysis if a widget is redundantly used in different launchers including the currently executed launcher of the one or more launchers;
determining if the widget is bound to the currently executed launcher of the one or more launchers; and
removing the widget service of the widget when it is determined the widget is not bound to the currently executed launcher.

15. The method of claim 11, further comprising:
comparing a widget service of one or more widgets currently not used by the terminal with running service information and a process identifier (ID) of the one or more widgets; and
determining to continue execution or stop execution of the widget service of the one or more widgets based on the comparison.

16. The method of claim 11, further comprising:
removing a process identifier (ID) of the widget corresponding to the widget service based on an unbind request to remove the widget service of the widget.

17. A method for controlling a widget service of a terminal, the method comprising:
changing a currently executed launcher operating in the terminal from a first launcher to a second launcher;
determining from a widget list if a widget is bound to the currently executed second launcher; and
terminating a widget service of one or more widgets determined as not bound to the currently executed second launcher based on the determination.

18. The method of claim 17, further comprising:
determining if a widget bound to the first launcher is identical to a widget bound to the currently executed second launcher;
maintaining execution of a widget service of a widget bound to the first launcher that is identical to the widget bound to the currently executed second launcher; and
removing the widget service of the widget bound to the first launcher when not identical to a widget bound to the currently executed second launcher.

19. A method for controlling a widget service of a terminal, the method comprising:
determining running service and process information of a widget service of one or more widgets;
determining if one or more widgets corresponding to the determined running service and the process information are used in one or more launchers and not used in a currently executed launcher; and
removing and unbinding the widget service of the one or more widgets that are used only in one or more launchers and not used in the currently executed launcher.

20. A method for controlling a widget service of a terminal, the method comprising:
determining if a widget generated on a screen of a terminal used in a currently executed launcher has been removed;
removing the widget service of the widget when it is determined the widget has been removed by unbinding the widget service of the widget corresponding to the removed widget from the currently executed launcher.
